(19) United States
(12) Patent Application Publication
(10) Pub. No.: US 2009/0225046 A1
(43) Pub. Date: Sep. 10, 2009

(54) TACTILE TRANSMISSION METHOD AND SYSTEM USING TACTILE FEEDBACK APPARATUS

(75) Inventors: Jong Ho Kim, Daejeon (KR); Dae Im Kang, Daejeon (KR); Yon Kyu Park, Daejeon (KR); Min Seok Kim, Daejeon (KR); Jae Hyuk Choi, Daejeon (KR)

Correspondence Address: HISCOCK & BARCLAY, LLP, 2000 HSBC PLAZA, 100 Chestnut Street, ROCHESTER, NY, 14604-2404, US

(73) Assignee: Korea Research Institute of Standards and Science, Daejeon (KR)

(21) Appl. No.: 12/186,864

(22) Filed: Aug. 6, 2008

(30) Foreign Application Priority Data
Mar. 10, 2008 (KR) 10-2008-0021976

(51) Int. Cl. G06F 3/041

(52) U.S. Cl. 345/173

(57) ABSTRACT

The present invention relates to a tactile transmission method and system in which when a user applies an action force to a tactile feedback apparatus on a transmission-side, a reaction force which reflects attributes of the action force and is proportional to the attributes is generated from a tactile feedback apparatus on a reception side so as to be transferred to a reception-side user. As described above, according to the tactile transmission method and system using tactile feedback apparatuses of the present invention, when a transmission-side user applies an action force to a tactile feedback apparatus on a transmission-side, a reaction force which reflects attributes of the action force and is proportional to the attributes is wirelessly transferred to a reception-side user located at a remote place, thereby enabling exchange of various contact information.

### CROSS-REFERENCE TO RELATED APPLICATIONS

This application claims priority to Korean Patent Applica-tion No. 10-2008-21976 filed Mar. 10, 2008.

### BACKGROUND OF THE INVENTION

1. Field of the Invention

The present invention relates to a tactile transmission method and system using a tactile feedback apparatus, and more specifically, to a tactile transmission method and system in which when a user applies an action force to a tactile feedback apparatus on a transmission-side, a reaction force which reflects attributes of the action force and is proportional to the attributes is generated from a tactile feedback apparatus on a reception side so as to be transferred to a reception-side user.

2. Background of the Related Art

A human being is incessantly interested in communication means which is more naturally, is easy to use and enables to provide various items of information. Thus, currently a mobile communication service is becoming a public service which changes the lifestyle of the human being through a continuous evolution from a simple voice call to a data/video call.

Nowadays, a tactile function of acquiring information on the surrounding environment through contacts, i.e., contact force, vibration, surface roughness and the like is recognized as a next-generation information gathering and transmission medium. However, an information transmission medium in a current voice and video call services entails a problems in that it is limited to voice, character and video, and does not experience a tactile sensation.

### SUMMARY OF THE INVENTION

The present invention has been made in an effort to solve the above problems, and it is an object of the present invention to provide a tactile transmission method and system in which when a user applies an action force to a tactile feedback apparatus on a transmission-side, a reaction force which reflects attributes of the action force and is proportional to the attributes is wirelessly transferred to a reception-side user located at a remote place, thereby enabling exchange of various contact information and human emotion.

To accomplish the above object, in one aspect, the present invention provides a tactile transmission method using tactile feedback apparatuses, comprising:

A tactile transmission method using tactile feedback apparatuses for allowing a user to input a position or operation command thereto using a pointing object, each tactile feedback apparatus including a touch input section as a medium that is applied with an action force of the pointing object and transmitted with a reaction force according to the action force, a tactile sensor disposed below the touch input section for sensing the action force and generating a predetermined signal, a controller for generating a predetermined control signal based on position information of the action force and the signal generated from the tactile sensor, and an actuator disposed beneath the touch input section and adapted to be driven to transmit the reaction force to the touch input section based on the control signal generated from the controller, such that when the action force is applied to the touch input section, the reaction force according to the action force is transferred to the user, wherein one of the tactile feedback apparatuses is used as a tactile feedback apparatus on a transmission side and the other of the tactile feedback apparatuses is used as a tactile feedback apparatus on a reception side, the tactile transmission method including:

a step of receiving an action force applied to a touch input section of the transmission-side tactile feedback apparatus by a transmission-side user;

a step of acquiring attribute information of the action force;

a step of transmitting the acquired attribute information of the action force to a central office system through a wired or wireless communication network;

a step of transmitting the attribute information of the action force to the reception-side tactile feedback apparatus through connection of the central office system to the reception-side tactile feedback apparatus; and

a step of driving a corresponding actuator of the reception-side tactile feedback apparatus based on a control signal generated from a controller of the reception-side tactile feedback apparatus that received the attribute information of the action force from the central office system,

whereby when the transmission-side user applies a certain action force to the transmission-side tactile feedback apparatus, a reception-side user can sense a reaction force according to the action force at a corresponding position of the reception-side tactile feedback apparatus.

Also, the step of acquiring the attribute information of the action force includes at least one of a step of acquiring position information of the applied action force, a step of detecting signal strength through the tactile sensor, and a step of acquiring movement trajectory information of the action force.

In addition, in the step of driving a corresponding actuator of the reception-side tactile feedback apparatus, the action region S′ where the reaction force is implemented on the reception-side tactile feedback apparatus is enlarged or reduced depending on the size of the touch input section of the reception-side tactile feedback apparatus.

Further, the step of transmitting the acquired attribute information of the action force to the central office system further comprises the steps of: allowing a controller of the transmission-side tactile feedback apparatus to generate a control signal based on the attribute information of the action force acquired by the transmission-side tactile feedback apparatus; and allowing the controller of the transmission-side tactile feedback apparatus to transmit the control signal to a corresponding actuator of the transmission-side tactile feedback apparatus,

Further, the tactile transmission method using tactile feedback apparatuses according to the present invention includes a step of driving the corresponding actuator of the transmission-side tactile feedback apparatus based on the control signal after the step of driving a corresponding actuator of the reception-side tactile feedback apparatus.

Besides, the step of driving the corresponding actuator of the reception-side tactile feedback apparatus comprises the steps of: determining whether or not the pointing object comes into close contact with the touch input section; driving the actuator if it is determined that the pointing object comes into close contact with the touch input section; and deactivating the actuator if it is determined that the pointing object does not come into close contact with the touch input section.

Also, the step of driving the corresponding actuator of the transmission-side tactile feedback apparatus based on the control signal comprises the steps of: determining whether or not the pointing object comes into close contact with the touch input section; driving the actuator if it is determined that the pointing object comes into close contact with the touch input section; and deactivating the actuator if it is determined that the pointing object does not come into close contact with the touch input section.

In another aspect, the present invention provides a tactile transmission system using tactile feedback apparatuses, comprising:

a transmission-side tactile feedback apparatus for allowing a transmission-side user to input a position or operation command thereto using a pointing object, the transmission-side tactile feedback apparatus including a touch input section as a medium that is applied with an action force of the pointing object and transmitted with a reaction force according to the action force, a tactile sensor disposed below the touch input section for sensing the action force and generating a predetermined signal, a controller for generating a predetermined control signal based on the signal generated from the tactile sensor, and an actuator disposed beneath the touch input section and adapted to be driven to transmit the reaction force to the touch input section based on the control signal generated from the controller, such that when the action force is applied to the touch input section, a transmission signal indicative of the attribute information of the action force is transmitted to a central office system server through a wired or wireless communication network;

a central office system for interconnecting the transmission-side tactile feedback apparatus and a reception-side tactile feedback apparatus, receiving a transmission signal from the transmission-side tactile feedback apparatus through a wired or wireless communication network, and tracing the position of the reception-side tactile feedback apparatus to transmit the transmission signal to the reception-side tactile feedback apparatus; and

the reception-side tactile feedback apparatus configured in the same manner as the transmission-side tactile feedback apparatus, processing the transmission signal received from central office system to a control signal to drive a corresponding actuator,

whereby when the transmission-side user applies a certain action force to the transmission-side tactile feedback apparatus, a reception-side user can sense a reaction force which reflects the attribute information of the action force and is proportional to the attribute information at a corresponding position of the reception-side tactile feedback apparatus.

Also, the transmission-side tactile feedback apparatus and the reception-side tactile feedback apparatus are mounted in cellular phones or PDA terminals, respectively.

Further, the pointing object is a finger, a palm, a stylus tip or a part of human body.

In addition, the touch input section is a touch screen or a touch pad.

Moreover, the attribute information at least one of position information of the pointing object, strength of the signal generated from the tactile sensor and movement trajectory of the action force.

Besides, the communication network is any one of Internet network, wired local area network (LAN), wireless local area network (LAN), ad hoc, trunked radio system (TRS), infrared, near field communication (NFC), Bluetooth and integrated services digital network (ISDN)

### BRIEF DESCRIPTION OF THE DRAWINGS

The above and other objects, features and advantages of the present invention will be apparent from the following detailed description of the preferred embodiments of the invention in conjunction with the accompanying drawings.

FIG. 1 shows a configuration of a tactile transmission system using tactile feedback apparatuses;

FIG. 2 shows a basic configuration of a touch screen apparatus;

FIGS. 3a and 3b are perspective views showing a state where a tactile sensor and an actuator are arranged in a tactile feedback apparatus;

FIG. 4 is a side cross-sectional view showing a tactile sensor;

FIG. 5 is a block diagram showing an installation flow of a tactile feedback apparatus for providing a tactile feedback;

FIG. 6 is a flow chart showing a tactile transmission method using tactile feedback apparatuses;

FIGS. 7a and 7are graphs showing the relationships between vibration parameters of an actuator according to an action force applied to a touch input section; and

FIG. 8 is a state view showing a region S where an action force is applied on a tactile feedback apparatus on a transmission side and a region S′ where a reaction force is implemented on a tactile feedback apparatus on a reception side.

### DETAILED DESCRIPTION OF THE PREFERRED EMBODIMENT

The preferred embodiments of the invention will be hereafter described in detail with reference to the accompanying drawings.

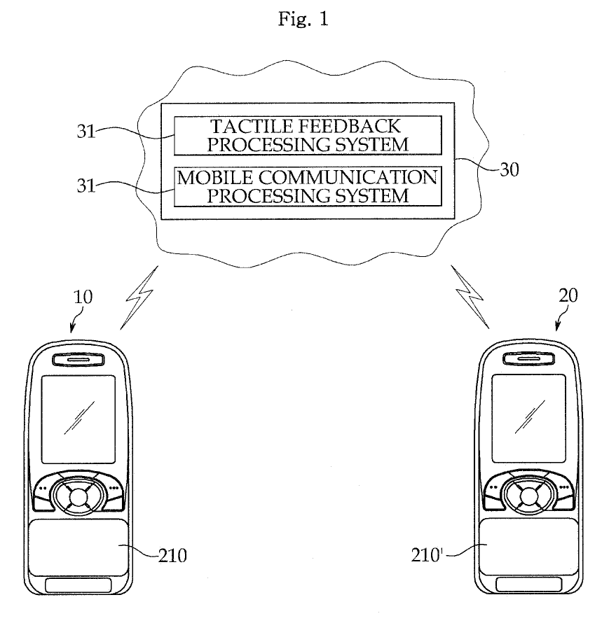

FIG. 1 shows a configuration of a tactile transmission system using tactile feedback apparatuses.

Referring to FIG. 1, one of the tactile feedback apparatuses is referred to as a tactile feedback apparatus 10 on a transmission side, and the other of the tactile feedback apparatuses is referred to as a tactile feedback apparatus 20 on a reception side. A central office system 30 as an information transmission medium is disposed between the transmission-side tactile feedback apparatus 10 and the reception-side tactile feedback apparatus 20 so as to allow information, signals and the like to be transmitted and received therebetwen.

Now, the construction and operation of the tactile feedback apparatuses 10 and 20 used in the present invention will be first reviewed and then a tactile transmission system including a central office system 30 will be described hereinafter.

### <Construction and Operation of Tactile Feedback Apparatuses>

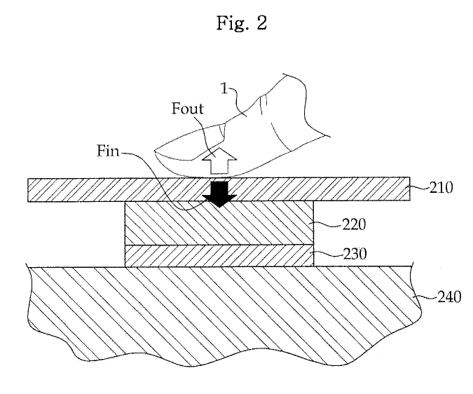

As shown in FIG. 2 the tactile feedback apparatuses are apparatuses for allowing a user to input a position or operation command thereto using a pointing object 1 (user's finger, stylus tip or the like). Each of the tactile feedback apparatuses includes a touch input section 210 as a medium that is applied with an action force Fᵢₙ of the pointing object and transmitted with a reaction force Fₒᵤₜ according to the action force, a tactile sensor 230 disposed below the touch input section 210 for sensing the action force Fᵢₙ and generating a predetermined signal, a controller 440 for generating a predetermined control signal based on a position where the action force Fᵢₙ is applied and the signal generated from the tactile sensor 230, and an actuator 220 disposed beneath the touch input section 210 and adapted to be driven to transmit the reaction force Fₒᵤₜ to the touch input section 210 based on the control signal generated from the controller.

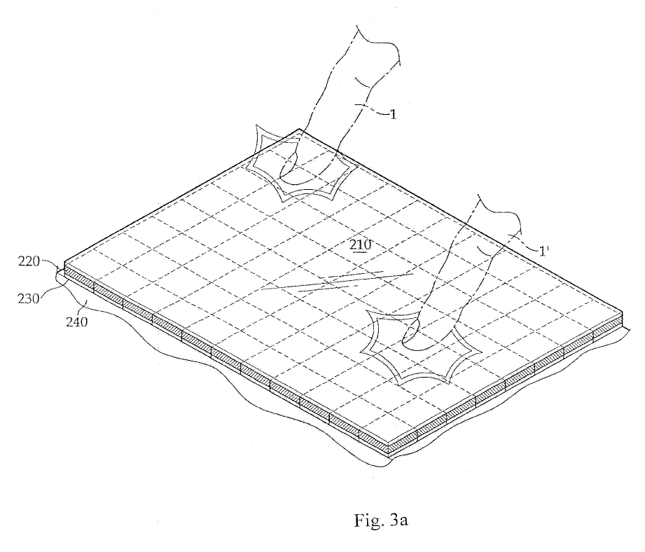

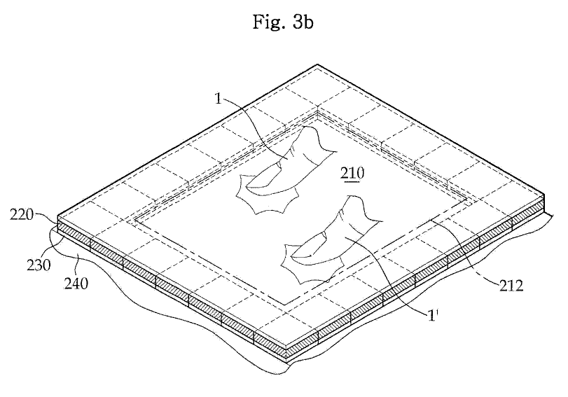

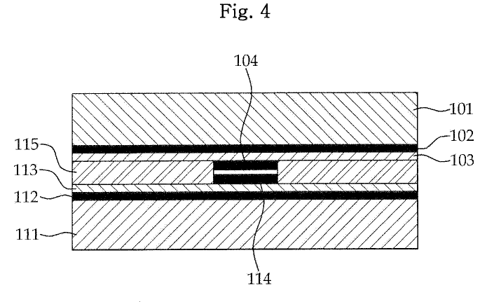

Preferably, the actuator 220 and the tactile sensor 230 disposed beneath and under the touch input section 210 may form a single unit body in such a fashion that multiple unit bodies are arranged in a matrix form as shown in FIG. 3a, or may be arranged along an edge of the touch input section 210. Since a plurality of unit bodies, i.e., one actuator 220 and one tactile sensor 230 are arranged to form a pair, even when an action force Fᵢₙ is applied to the touch input section 210 in a multi-touch or drag manner using the pointing objects 1 and 1′, the action force Fᵢₙ can be sensed.

FIG. 2 shows a basic configuration of a touch screen apparatus wherein the actuator 220 is positioned on top of the tactile sensor 230.

The positions of the actuator 220 and the tactile sensor 230 may be of course changed each other. Also, the concrete wirings of the actuator and the tactile sensor are apparent within the scope of those skilled in the art, and thus detailed descriptions thereof will be omitted.

In case where the touch input section 210 is a touch pad mainly used in notebook computers, the tactile sensor 230 and the actuator 220 are arranged at the touch input section 210 in the matrix form as shown in FIG. 3a. In case where the touch input section 210 is a touch screen used in cellular phones, the tactile sensor 230 and the actuator 220 are preferably arranged along the edge of the touch input section as shown in FIG. 3b so as to prevent degradation of a function of the display unit 212.

The tactile sensor 230 detects a signal of the action force applied to the touch input section. The tactile sensor comprises an upper plate manufactured by forming a coating layer 102 and a metal layer 103 on a polymer film 101 of a certain thickness in order and forming a resistive element 104 on the metal layer 103, and a lower plate manufactured by forming a coating layer 112 and a metal layer 113 on a polymer film 111 of a certain thickness in order and forming a resistive element 114 on the metal layer 113. The tactile sensor is configured by bonding the sensor to include a spacer 115 so that the resistive element 104 of the upper plate faces the resistive element 114 of the lower plate.

The actuator 220 is driven (for example, linear movement, rotation, translation, etc.) to transmit a reaction force to the touch input section 210 based on a control signal generated from the controller.). A piezoelectric actuator, voice coil actuator, polymer actuator, or the like can be used as the actuator 220.

The controller (not shown), particularly, the controller of the tactile feedback apparatus 10 on a transmission side serves to generate a control signal containing attribute information regarding strength, texture and the like of the action force Fᵢₙ, based on the signal generated from the tactile sensor 230 and the position information of the action force Fᵢₙ applied to the touch input section 210, and send the control signal to the actuator 220. In the present invention, the attribute information of the action force Fᵢₙ) must be ultimately sent to the tactile feedback apparatus 20 on a reception side, and hence the controller may generate a transmission signal which reflects the attribute information of action force Fᵢₙ.

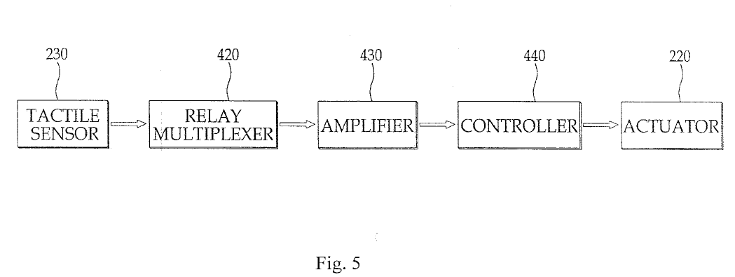

FIG. 5 is a block diagram showing an installation flow of a tactile feedback apparatus for providing a tactile feedback to a user.

Now, the basic driving method of the tactile feedback apparatus will be described in brief with reference to FIG. 5.

First, when a user applies an action force Fᵢₙ, a certain signal is generated from the tactile sensor 230 where a signal line is formed. Before being applied to the control unit 440, the signal generated from the tactile sensor 230 is preferably processed through a relay multiplexer 420 for sequentially detecting the signals indicative of the action force generated from the tactile sensor 230 and an amplifier 430 for amplifying the signal of the multiplexer 420 to a certain level.

Here, various types of amplifiers such as an analog amplifier, digital amplifier, voltage amplifier, and the like may be used as the amplifier 430. In addition, the tactile feedback apparatus preferably further comprises a noise cancellation unit (not shown: e.g., a filter or the like) for removing noises included in the signal generated from the tactile sensor 230. By removing the noises, efficiency can be enhanced when the reaction force is implemented. Since the digital amplifier consumes less power and is small in size, it can be easily embedded in a computer, a portable electronic product, or the like. Since the digital amplifier can be manufactured as one ASIC (application specific integrated circuit), it is advantageous in that it can be manufactured on a large scale. When the digital amplifier is used, the tactile feedback apparatus preferably further includes an analog-to-digital converter (ADC) (not shown) or a digital-to-analog converter (DAC) (not shown) for performing conversion of between analog and digital signals.

The control signal generated based on the attribute information of the action force and processed by the control unit 440 is applied to the actuator 220, and the actuator 220 performs a linear, translational or rotational motion or the like to deliver the reaction force to the user.

### <Tactile Transmission System>

As mentioned above, the tactile transmission system includes a tactile feedback apparatus 10 on a transmission side, a tactile feedback apparatus 20 on a reception side and a central office system 30.

The tactile feedback apparatuses 10 and 20 on the transmission and reception sides are mounted in mobile communication devices such as enable cellular phones, personal digital assistants (PDAs) or the like to enable delivery of tactile information between a reception-side user and a transmission-side user who are located in remote places. The construction and operation of the tactile feedback apparatuses 10 and 20 have been described previously.

The central office system 30 includes a tactile feedback processing system 31 and a mobile communication processing system 32. The central office system 30 generally transmits voice, video call, data communication and the like in a CDMA, TDMA or GSM scheme, and transmits the attribute information regarding the action force. The central office system 30 is connected to a plurality of intermediate base stations and a network.

The tactile feedback processing system 31 serves to transmit the information regarding the action force Fᵢₙ. That is, the tactile feedback processing system 31 receives the attribute information regarding the action force Fᵢₙ acquired by the tactile feedback apparatus 10 on a transmission side from the tactile feedback apparatus 10 on a transmission side and sends the received attribute information to the tactile feedback apparatus 20 on a reception side. The attribute information of the action force Fᵢₙ) includes application position, strength and texture of the action force Fᵢₙ, movement trajectory of the pointing object, and the like. The attribute information is processed as a transmission signal by the controller of the transmission-side tactile feedback apparatus 10 so as to be transmitted to the central office system through a wired or wireless communication network. As an example of the communication network, any one of Internet network, wired local area network (LAN), wireless local area network (LAN), ad hoc, trunked radio system (TRS), infrared, near field communication (NFC), Bluetooth and integrated services digital network (ISDN) can be used.

In case where the tactile feedback apparatus is mounted in a portable terminal, the mobile communication processing system 32 includes a base station server (not shown) for enabling a basic mobile communication, a mobile switching center (MSC) server (not shown), and other devices necessary for communication. The non-shown base station server communicates with the portable terminal through a wireless channel, and transmits a signal received from the portable terminal through the wireless channel to the mobile switching center server, and transmits a signal received from the mobile switching center server to the portable terminal through the wireless channel in a reverse direction. Also, the non-shown mobile switching center server serves to trace the position of the portable terminal to enable a mobile communication service. This is apparent to those skilled in the art, and thus detailed descriptions thereof will be omitted.

In case where the tactile feedback apparatus is mounted in a personal digital assistant (PDA), the mobile communication processing system 32 includes a series of devices necessary for allowing the PDA to receive information using wireless internet line, WiBro, wireless LAN and the like. This is also apparent to those skilled in the art, and thus detailed descriptions thereof will be omitted.

In the present invention, a user's finger, a stylus or the like is given as a representative example of the pointing object 1, but a part (e.g., palm, face and the like) of a human body for delivering a tactile sensation may be given as an example of the pointing object.

### <Tactile Transmission Method>

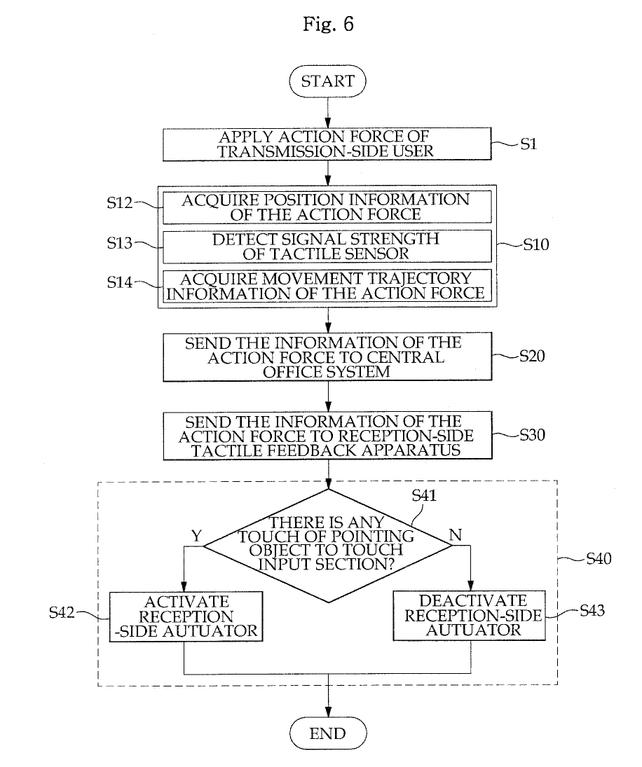

As shown in FIG. 6, the tactile transmission method using tactile feedback apparatuses includes a step S1 of receiving an action force Fᵢₙ applied to the touch input section of the transmission-side tactile feedback apparatus 10 by a transmission-side user, a step S10 of acquiring attribute information of the action force Fᵢₙ, a step S20 of transmitting the attribute information of the action force Fᵢₙ to the central office system 30, a step S30 of transmitting the attribute information of the action force Fᵢₙ to the reception-side tactile feedback apparatus 20 through connection of the central office system 30 to the reception-side tactile feedback apparatus 20, a step S40 of driving a corresponding actuator of the reception-side tactile feedback apparatus 20 that received the attribute information of the action force Fᵢₙ from the central office system 30 based on the attribute information of the action force Fᵢₙ f and transferring a reaction force for the action force to a reception-side user.

First, in the step S1 of receiving an action force Fᵢₙ applied by a transmission-side user, when the transmission-side user applies a certain force or pressure to the touch input section 210 of the transmission side tactile feedback apparatus 10 using the pointing object 1 so as to input position and operation, an action force Fᵢₙ according to the applied certain force or pressure is inputted to the touch input section 210.

Next, the step S10 of acquiring the attribute information of the action force Fᵢₙ, will be reviewed hereinafter.

When the transmission-side user applies the action force Fᵢₙ to the touch input section 210 of the transmission side tactile feedback apparatus 10 on a cellular phone or a PDA terminal mounted with the transmission-side tactile feedback apparatus 10 using the pointing object 1, a signal indicative of the attribute information of the action force Fᵢₙ is generated from the tactile sensor.

The attribute information of the action force Fᵢₙ includes position and strength of the applied action force Fᵢₙ, movement trajectory of the pointing object 1, and the like. Thus, preferably, the step S10 of acquiring the attribute information of the action force includes a step S11 of acquiring position information of the action force, a step S12 of detecting signal strength of the tactile sensor, and a step S13 of acquiring movement trajectory information of the action force.

More specifically, in the step S11 of acquiring position information of the action force, the position where of the action force is applied can be grasped indirectly by tracing the position (x and y coordinate values) of the tactile sensor from which a certain signal is generated. Alternatively, the application position of the action force can be grasped in such a fashion that the touch input section (touch pad or touch screen) acquires the position information (x and y coordinate values) of the pointing object 1. Such a fashion is apparent within the scope of those skilled in the art, and thus detailed descriptions thereof will be omitted.

Now, the step S12 of detecting signal strength through the tactile sensor will be discussed hereinafter in more detail.

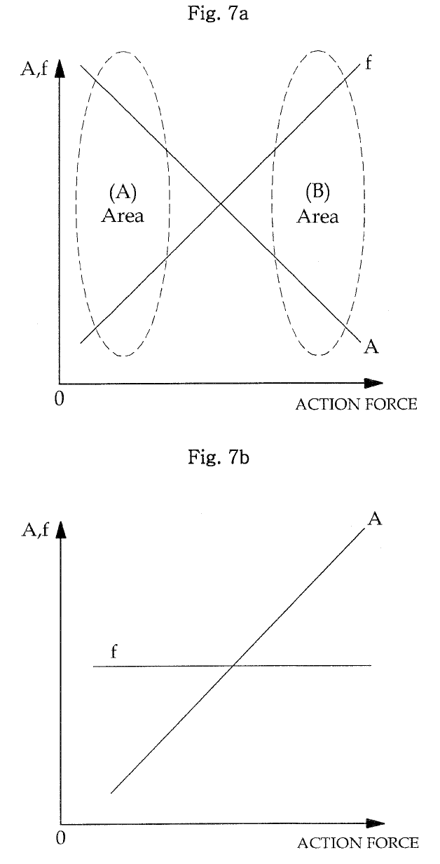

The strength, texture and the like of the action force, are detected by the tactile sensor 230 of the transmission-side the tactile feedback apparatus 10. The strength of the action force can be processed by the magnitude of output voltage of the tactile sensor 230, superposition of a certain signal or the like. The strength and the texture of the action force can be represented by the relationship between a frequency f and an amplitude A as shown in FIGS. 7a and 7b. In FIGS. 7a and 7b, an x-axis denotes an action force, and an y-axis denotes a vibration parameter of the actuator, which indicates an amplitude A and a frequency f.

FIGS. 7a and 7b are graphs showing the relationships between vibration parameters of an actuator according to an action force applied to a touch input section.

In one embodiment, in order to transfer a texture, i.e., a soft or hard feeling of the touch input section, the amplitude A and the frequency f are in inverse proportion to each other. As shown in FIG. 7a, when it is desired to transfer a soft feeling (region A) to the touch input section by driving the actuator to which the control signal is applied, the frequency f has a small value and the amplitude A has a large value. On the contrary, when it is desired to transfer a hard feeling (region B) to the touch input section, the frequency f has a large value and the amplitude A has a small value.

In FIG. 7b, there is shown a relationship in which when the frequency f is constant, the amplitude A is variable according to the action force Fᵢₙ. It is of course noted that information of the control signal can be diversified in various numbers of cases besides the relationship between the amplitude A and the frequency f shown in FIGS. 7a and 7b.

In addition, the step S13 of acquiring movement trajectory information of the action force will be discussed hereinafter. The movement trajectory of action force Fᵢₙ is created by dragging the pointing object 1 on the touch input section 210 while depressing the pointing object 1. The attribute information of the action force Fᵢₙ according to the movement trajectory can consist of continuous actions of acquisition of information on application position, strength, texture and the like of the action force. Of course, this can consist of various methods besides one embodiment of the acquisition of the movement trajectory information.

Subsequently, the step S20 of transmitting the attribute information of the action force Fᵢₙ to the central office system 30 will be discussed hereinafter.

The attribute information including position and strength and texture of the action force, and the movement trajectory of the pointing object acquired in the step S10 of acquiring the attribute information of the action force is converted into a predetermined signal by the controller of the transmission-side tactile feedback apparatus 10 and then is transmitted to the central office system 30 through a wired or wireless communication network. The attribute information of the action force, i.e., the signal transmitted to the central office system 30 can be compressed, segmented and the like in a predetermined packet in consideration of signal transfer and processing rates.

Next, the step S30 of transmitting the attribute information of the action force Fᵢₙ to the reception-side tactile feedback apparatus 20 will be discussed hereinafter.

The mobile communication processing system 32 of the central office system 30 traces the position of the reception-side tactile feedback apparatus 20, and the tactile feedback processing system 31 transmits a transmission signal which reflects the attribute information of the action force received from the transmission-side tactile feedback apparatus 10 to a corresponding reception-side tactile feedback apparatus 20 through the wired or wireless communication network. In this case, the transmission signal can be compressed, segmented and the like in a predetermined packet in consideration of signal transfer and processing rates.

Last, the step S40 of driving the actuator of the reception-side tactile feedback apparatus 20 will be discussed hereinafter.

The transmission signal transmitted from central office system 30 is applied to a controller of the reception-side tactile feedback apparatus 20. The controller of the reception-side tactile feedback apparatus 20 processes the applied signal to a predetermined control signal for application to a corresponding actuator of the reception-side tactile feedback apparatus 20. Then, the actuator of the reception-side tactile feedback apparatus 20 that received the control signal is driven (linear, rotational or translational motion, or the like) so as to transfer a reaction force Fₒᵤₜ) according to the action force Fᵢₙ) to a reception-side user. In this case, the corresponding actuator refers to an actuator of the reception-side tactile feedback apparatus that is required to be driven to transfer the reaction force to the reception-side user.

At this time, preferably, the controller of the reception-side tactile feedback apparatus 20 re-processes the transmission signal received from the transmission-side tactile feedback apparatus 10 so as to be adapted to the environment of the reception-side tactile feedback apparatus 20. That is, if the transmission-side tactile feedback apparatus 10 and the reception-side tactile feedback apparatus 20 are different from each other in terms of the kind of apparatus, it is required that the controller should generate an appropriate control signal in consideration of the environment (the number and arrangement of actuators and tactile sensors, the size and strength of the touch input section, etc.) of the reception-side tactile feedback apparatus 20. Of course, if the transmission-side tactile feedback apparatus 10 and the reception-side tactile feedback apparatus 20 are the same as each other in terms of the kind or specification of apparatus, the reaction force may be generated on a one-to-one relationship basis.

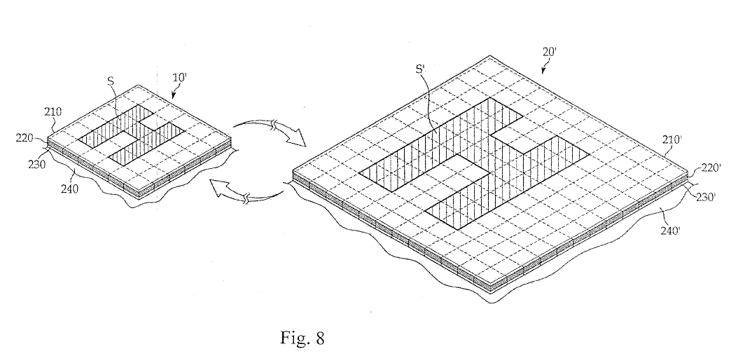

FIG. 8 is a state view showing a region S where an action force is applied on a tactile feedback apparatus on a transmission side and a region S′ where a reaction force is implemented on a tactile feedback apparatus on a reception side.

One embodiment of the generation of the reaction force based on one-to-one relationship basis will be described hereinafter with reference to FIG. 8.

As shown in FIG. 8, the region S′ where the reaction force Fₒᵤₜ is implemented on the reception-side tactile feedback apparatus 20 can be enlarged or reduced depending on the size of the touch input section 210′ of the reception-side tactile feedback apparatus 20. In this case, the operation in the tactile feedback apparatus will be described in which unit bodies each consisting of the tactile sensor 230 and the actuator 220 are arranged in a matrix form.

In case where it is assumed that the area of the touch input section 210′ of the reception-side tactile feedback apparatus 20 is four times as many as that of the touch input section 210 of the transmission-side tactile feedback apparatus 10′, when an action force Fᵢₙ is applied to an “H”-shaped region on the touch input section 210, a reaction force Fₒᵤₜ transferred to the touch input section 210′ and implemented in an “H”-shaped region on the touch input section 210′ may be enlarged to be doubled depending on a size ratio of the touch input section 210′. For reference, the “H”-shaped region shown in FIG. 8 may be applied as the trajectory of the pointing object 1, and may be applied by depressing an “H”-shaped object at a time.

On the contrary, in case where the area of the touch input section 210′ of the reception-side tactile feedback apparatus 20′ is smaller than that of the touch input section 210 of the transmission-side tactile feedback apparatus 10, the region S′ where the reaction force is implemented can be reduced. Also, it is of course noted that although the touch input sections 210 and 210′ of transmission-side tactile feedback apparatus 10 and the reception-side tactile feedback apparatus 20′ are different in size from each other, the region S′ where the reaction force is implemented may be configured to be identical to the region S where the action force is applied. This operation can be processed by the controller of the reception-side tactile feedback apparatus 20′ in consideration of the environment of the reception-side tactile feedback apparatus 20′.

Further, the reaction force Fₒᵤₜ may be transferred to the reception-side user as well as the transmission-side user who applies the action force (step S40′ of driving the actuator of the transmission-side tactile feedback apparatus 10). As mentioned above, in the step S20 of transmitting the attribute information of the action force Fᵢₙ to the central office system, it is preferably to transmit a signal for driving the controller of the transmission-side tactile feedback apparatus. That is, the controller of the transmission-side tactile feedback apparatus generates a predetermined control signal based on the position information of the applied action force and the signal generated from the tactile sensor, at which time, the control signal is transmitted to the actuator of the transmission-side tactile feedback apparatus. The corresponding actuator which has received the control signal from the controller from the transmission-side tactile feedback apparatus is driven (step S40′) to cause the reaction force Fₒᵤₜ to be transferred to the transmission-side user. The driving method of the actuator of the transmission-side tactile feedback apparatus is the same as that of the tactile feedback apparatus, and thus the detailed description thereof will be omitted hereinafter.

Preferably, the transmission- and reception-side actuator driving steps S40 and S40′ include: a step S41 of determining whether or not the pointing object comes into close contact with the touch input section; a step S42 of driving the actuator if it is determined that the pointing object comes into close contact with the touch input section; and a step S42 of deactivating the actuator if it is determined that the pointing object does not come into close contact with the touch input section.

In case where the pointing object 1 which can sense the reaction force Fₒᵤₜ does not come into close contact with the touch input section, the reaction force Fₒᵤₜ may be set to be 0 N so as to save the electric power. This can contribute to the saving of the power in using cellular phones, PDA terminals or the like operated by a portable battery or the like. This operation can be performed by the controllers of the transmission- and reception-side tactile feedback apparatuses in such a fashion as not to output the control signal to the corresponding actuators.

### Modified Embodiment

In another embodiment, the tactile transmission method and system using tactile feedback apparatuses can be applied even in case where the tactile feedback apparatuses are mounted in the portable terminals or the PDA terminals as well as are mounted in computers, portable computers, smart boards and the like.

In yet another embodiment, the tactile transmission method and system using tactile feedback apparatuses can of course be applied in case where the transmission- and reception-side tactile feedback apparatuses are used as different kinds of apparatuses such as a cellular phone and a PDA terminal, respectively. In this case, since the specifications (the number and arrangement of actuators and tactile sensors, the size and strength of the touch input section, etc.) of the reception-side tactile feedback apparatus and the transmission-side tactile feedback apparatus are different from each other, the controller of the reception-side tactile feedback apparatus must re-process the signal transmitted to the reception-side tactile feedback apparatus from the transmission-side tactile feedback apparatus so as to be adapted to the environment of the reception-side tactile feedback apparatus.

In still another embodiment, the transmission-side tactile feedback apparatus 10 and the reception-side tactile feedback apparatus 20 may be configured such that the attribute information of the action force is sent out unidirectionally or bidirectionally in a state where a phone call is established between two cellular phones.

Besides these embodiments, the tactile transmission system may be configured such that the attribute information of the action force is transmitted to the reception-side tactile feedback apparatus 20 on a unidirection and one-time transmission basis when the transmission-side tactile feedback apparatus 10 is connected to the reception-side tactile feedback apparatus 20 after the transmission-side tactile feedback apparatus 10 transmits the attribute information of the action force to the central office system 30 and temporarily stores it in the central office system, as in short message service (SMS) or voice message service.

As described above, according to the tactile transmission method and system using tactile feedback apparatuses of the present invention, when a transmission-side user applies an action force to a tactile feedback apparatus on a transmission-side, a reaction force which reflects attributes of the action force and is proportional to the attributes is wirelessly transferred to a reception-side user located at a remote place, thereby enabling exchange of various contact information.

In addition, in the information exchange and communication of users performing the mobile communication, diversification of an information transfer medium is promoted. Particularly, in the communication of visible and audible disabled people, inconvenience of the video and voice communication can be eliminated and information transmission can be performed in various manners.

Furthermore, strength, texture and the like of the action force applied by the transmission-side user is transferred to the reception-side user as a reaction force, thereby further promoting exchange of human emotion.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A tactile transmission method using tactile feedback apparatuses for allowing a user to input a position or operation command thereto using a pointing object, each tactile feedback apparatus including a touch input section as a medium that is applied with an action force of the pointing object and transmitted with a reaction force according to the action force, a tactile sensor disposed below the touch input section for sensing the action force and generating a predetermined signal, a controller for generating a predetermined control signal based on position information of the action force and the signal generated from the tactile sensor, and an actuator disposed beneath the touch input section and adapted to be driven to transmit the reaction force to the touch input section based on the control signal generated from the controller, such that when the action force is applied to the touch input section, the reaction force according to the action force is transferred to the user, wherein one of the tactile feedback apparatuses is used as a tactile feedback apparatus on a transmission side and the other of the tactile feedback apparatuses is used as a tactile feedback apparatus on a reception side, the tactile transmission method comprising:
a step of receiving an action force applied to a touch input section of the transmission-side tactile feedback apparatus by a transmission-side user;
a step of acquiring attribute information of the action force;
a step of transmitting the acquired attribute information of the action force to a central office system through a wired or wireless communication network;
a step of transmitting the attribute information of the action force to the reception-side tactile feedback apparatus through connection of the central office system to the reception-side tactile feedback apparatus; and
a step of driving a corresponding actuator of the reception-side tactile feedback apparatus based on a control signal generated from a controller of the reception-side tactile feedback apparatus that received the attribute information of the action force from the central office system,
whereby when the transmission-side user applies a certain action force to the transmission-side tactile feedback apparatus, a reception-side user can sense a reaction force according to the action force at a corresponding position of the reception-side tactile feedback apparatus.

2. The tactile transmission method using tactile feedback apparatuses according to claim 1, wherein the step of acquiring the attribute information of the action force comprises at least one of a step of acquiring position information of the applied action force, a step of detecting signal strength through the tactile sensor, and a step of acquiring movement trajectory information of the action force.

3. The tactile transmission method using tactile feedback apparatuses according to claim 1, wherein in the step of driving a corresponding actuator of the reception-side tactile feedback apparatus, the action region where the reaction force is implemented on the reception-side tactile feedback apparatus is enlarged or reduced depending on the size of the touch input section of the reception-side tactile feedback apparatus.

4. The tactile transmission method using tactile feedback apparatuses according to claim 1, wherein the step of transmitting the acquired attribute information of the action force to the central office system further comprises the steps of:
allowing a controller of the transmission-side tactile feedback apparatus to generate a control signal based on the attribute information of the action force acquired by the transmission-side tactile feedback apparatus; and
allowing the controller of the transmission-side tactile feedback apparatus to transmit the control signal to a corresponding actuator of the transmission-side tactile feedback apparatus, and
further comprising a step of driving the corresponding actuator of the transmission-side tactile feedback apparatus based on the control signal, after a step of driving a corresponding actuator of the reception-side tactile feedback apparatus.

5. The tactile transmission method using tactile feedback apparatuses according to claim 1, wherein the step of driving the corresponding actuator of the reception-side tactile feedback apparatus comprises the steps of:
determining whether or not the pointing object comes into close contact with the touch input section;
driving the actuator if it is determined that the pointing object comes into close contact with the touch input section; and
deactivating the actuator if it is determined that the pointing object does not come into close contact with the touch input section.

6. The tactile transmission method using tactile feedback apparatuses according to claim 4, wherein the step of driving the corresponding actuator of the transmission-side tactile feedback apparatus based on the control signal comprises the steps of:
determining whether or not the pointing object comes into close contact with the touch input section;
driving the actuator if it is determined that the pointing object comes into close contact with the touch input section; and
deactivating the actuator if it is determined that the pointing object does not come into close contact with the touch input section.

7. A tactile transmission system using tactile feedback apparatuses, comprising:
a transmission-side tactile feedback apparatus for allowing a transmission-side user to input a position or operation command thereto using a pointing object, the transmission-side tactile feedback apparatus including a touch input section as a medium that is applied with an action force of the pointing object and transmitted with a reaction force according to the action force, a tactile sensor disposed below the touch input section for sensing the action force and generating a predetermined signal, a controller for generating a predetermined control signal based on the signal generated from the tactile sensor, and an actuator disposed beneath the touch input section and adapted to be driven to transmit the reaction force to the touch input section based on the control signal generated from the controller, such that when the action force is applied to the touch input section, a transmission signal indicative of the attribute information of the action force is transmitted to a central office system server through a wired or wireless communication network;
a central office system for interconnecting the transmission-side tactile feedback apparatus and a reception-side tactile feedback apparatus, receiving a transmission signal from the transmission-side tactile feedback apparatus through a wired or wireless communication network, and tracing the position of the reception-side tactile feedback apparatus to transmit the transmission signal to the reception-side tactile feedback apparatus; and
the reception-side tactile feedback apparatus configured in the same manner as the transmission-side tactile feedback apparatus, processing the transmission signal received from central office system to a control signal to drive a corresponding actuator,
whereby when the transmission-side user applies a certain action force to the transmission-side tactile feedback apparatus, a reception-side user can sense a reaction force which reflects the attribute information of the action force and is proportional to the attribute information at a corresponding position of the reception-side tactile feedback apparatus.

8. The tactile transmission system using tactile feedback apparatuses according to claim 7, wherein the transmission-side tactile feedback apparatus and the reception-side tactile feedback apparatus are mounted in cellular phones or PDA terminals, respectively.

9. The tactile transmission system using tactile feedback apparatuses according to claim 7, wherein the pointing object is a finger, a palm, a stylus tip or a part of human body.

10. The tactile transmission system using tactile feedback apparatuses according to claim 7, wherein the touch input section is a touch screen or a touch pad.

11. The tactile transmission system using tactile feedback apparatuses according to claim 7, wherein the attribute information at least one of position information of the pointing object, strength of the signal generated from the tactile sensor and movement trajectory of the action force.

12. The tactile transmission system using tactile feedback apparatuses according to claim 7, wherein the communication network is any one of Internet network, wired local area network (LAN), wireless local area network (LAN), ad hoc, trunked radio system (TRS), infrared, near field communication (NFC), Bluetooth and integrated services digital network (ISDN).
